(19) United States
(12) Patent Application Publication
(10) Pub. No.: US 2018/0224960 A1
(43) Pub. Date: Aug. 9, 2018

(54) CONDUCTIVE STRUCTURE AND PREPARATION METHOD THEREFOR

(71) Applicant: LG CHEM LTD., Seoul (KR)

(72) Inventors: Chan Hyoung PARK, Daejeon (KR); Ki-Hwan Kim, Daejeon (KR); Jin Hyong LIM, Daejeon (KR); IIha LEE, Daejeon (KR)

(73) Assignee: LG CHEM LTD., Seoul (KR)

(21) Appl. No.: 15/506,071

(22) PCT Filed: Sep. 23, 2015
(86) PCT No.: PCT/KR2015/010029

§ 371 Date: Feb. 23, 2017

(30) Foreign Application Priority Data
Sep. 24, 2014 (KR) 10-2014-0127603

(51) Int. Cl. G06F 3/044; G06F 3/045; G06F 3/03; H01B 13/00

(52) U.S. Cl. CPC G06F 3/044; G06F 3/045; G06F 2203/04103; H01B 13/0026; G06F 3/0317

(57) ABSTRACT

The present application relates to a conductive structure and a method for manufacturing the same. The conductive structure according to an exemplary embodiment of the present application includes a substrate, a metal layer which is provided on the substrate and includes copper, a discoloration preventing layer provided on the metal layer, and a darkening layer which is provided on the discoloration preventing layer and includes one or more of copper oxide, copper nitride, copper oxynitride, aluminum oxide, aluminum nitride, and aluminum oxynitride.

### TECHNICAL FIELD

The present application claims priority from Korean Patent Application No. 10-2014-0127603, filed on Sep. 24, 2014, at the KIPO, the disclosure of which is incorporated herein by reference in its entirety.

The present application relates to a conductive structure and a method for manufacturing the same.

### BACKGROUND ART

In general, a touch screen panel may be classified as follows depending on a detection mode of signals. That is, there are a resistive type of sensing a position which is pressed down by pressure through a change in current or voltage value while a direct current voltage is applied thereto, a capacitive type of using a capacitance coupling while an alternating current voltage is applied thereto, an electromagnetic type of sensing a selected position by a change in voltage while a magnetic field is applied thereto, and the like.

Recently, as the need for a large-area touch screen panel increases, there is a need for developing a technology that may implement a large touch screen panel having excellent visibility while reducing the resistance of an electrode.

### DETAILED DESCRIPTION OF THE INVENTION

### Technical Problem

In the technical field to which the present invention pertains, there is a need for developing a technology for improving a performance of touch screen panels of the various modes.

### Technical Solution

An exemplary embodiment of the present application provides a conductive structure including: a substrate; a metal layer which is provided on the substrate and includes copper; a discoloration preventing layer provided on the metal layer; and a darkening layer which is provided on the discoloration preventing layer and includes one or more of copper oxide, copper nitride, copper oxynitride, aluminum oxide, aluminum nitride, and aluminum oxynitride.

Another exemplary embodiment of the present application provides a method for manufacturing a conductive structure including: forming a metal layer including copper on a substrate; forming a discoloration preventing layer on the metal layer; and forming a darkening layer including one or more of copper oxide, copper nitride, copper oxynitride, aluminum oxide, aluminum nitride, and aluminum oxynitride on the discoloration preventing layer.

Still another exemplary embodiment of the present application provides an electronic element including the conductive structure.

### Advantageous Effects

The conductive structure according to an exemplary embodiment of the present application may prevent reflection by a conductive pattern without affecting conductivity of the conductive pattern, and may improve concealment of the conductive pattern by improving absorbance of the conductive pattern.

Further, the conductive structure according to the exemplary embodiment of the present application includes a discoloration preventing layer between a metal layer including copper and a darkening layer including one or more of copper oxide, copper nitride, copper oxynitride, aluminum oxide, aluminum nitride, and aluminum oxynitride, thereby preventing copper of the metal layer from being diffused onto the darkening layer. Therefore, the degeneration of the interface between the metal layer and the darkening layer may be suppressed and stability at a high temperature and high humidity may be maximized.

Furthermore, it is possible to develop an electronic element having improved visibility such as a touch screen panel, a display device, or a solar cell using the conductive structure according to an exemplary embodiment of the present invention.

### BRIEF DESCRIPTION OF DRAWINGS

FIG. 1 is a view schematically illustrating a laminated structure of a conductive structure as an exemplary embodiment of the present application.

FIG. 2 is a view illustrating a composition before and after performing a thermal treatment on a conductive structure of the related art.

FIG. 3 is a view obtained by measuring change in reflectance before and after performing a thermal treatment on a conductive structure according to Example 1, as an exemplary embodiment of the present application.

FIG. 4 is a view obtained by measuring change in reflectance before and after performing a thermal treatment on a conductive structure according to Comparative Example 1, as an exemplary embodiment of the present application.

FIG. 5 is a view obtained by measuring a change in reflectance before and after performing a thermal treatment on a conductive structure according to Example 2, as an exemplary embodiment of the present application.

FIG. 6 is a view obtained by measuring a change in reflectance before and after performing a thermal treatment on a conductive structure according to Example 3, as an exemplary embodiment of the present application.

FIG. 7 is a view obtained by measuring a high temperature discoloration degree according to a thickness of a Ti layer which is a discoloration preventing layer of a conductive structure, as an exemplary embodiment of the present application.

FIG. 8 is a view obtained by measuring a high temperature and high humidity stability according to a thickness of a Ti layer which is a discoloration preventing layer of a conductive structure, as an exemplary embodiment of the present application.

### BEST MODE

Hereinafter, the present application will be described in more detail.

In the present specification, a display device collectively refers to a TV, a computer monitor or the like and includes a display device that forms an image, and a case that supports the display device.

Examples of the display device include a plasma display panel (PDP), a liquid crystal display (LCD), an electrophoretic display, a cathode-ray tube (CRT), an OLED display, and the like. The display device may include an RGB pixel pattern for implementing an image and an additional optical filter.

Meanwhile, in relation to the display device, as the spread of smart phones, tablet PCs, IPTVs, and the like is accelerated, a need for a touch function in which a human hand serves as a direct input device without a separate input device, such as a keyboard, a remote control, or the like, is gradually increasing. Further, a multi-touch function that is capable of recognizing a specific point and writing is also required.

Currently, most commercially available touch screen panels (TSP) are based on a transparent conductive ITO thin film, but have problems in that a touch recognition speed is decreased and an additional compensation chip for overcoming the decrease of the touch recognition speed should be introduced because of a RC delay due to relatively high sheet resistance of the ITO transparent electrode when a touch screen panel having a large area is applied (minimum 150 Ω/square, ELECRYSTA products manufactured by Nitto Denko, Co., Ltd.).

The present inventors have studied a technology for replacing the transparent ITO thin film with a metal fine pattern. Thus, the present inventors have found that when a metal thin film having high electrical conductivity is used for an electrode of a touch screen panel, a glare to the eyes and the like may occur due to high reflectance to external light, haze values, and the like along with a problem in that patterns may be recognized well to the human eyes in terms of visibility caused by high reflectance in order to implement a specific shape of fine electrode pattern. In addition, the present inventors have found that an expensive target cost is required during the manufacturing process, or there may be many cases in which the process is complex.

Further, when a transparent electrode is used for the metal fine line, the most serious problem may be a reflection color. Since a visibility problem such as glittering light may be caused by an external light source, due to unique metal gloss, an additional layer which may lower reflectance may be formed on a surface of the metal.

Further, a metal fine line which is manufactured with a constant line width and a constant pitch has a low electric resistance and has a property in that light transmits through most of the area of the metal fine line. Therefore, the metal fine line is actively studied as a next-generation transparent electrode and touch sensor.

Specifically, among the metal fine lines, a Cu metal fine line is cheap and has a high electric conductivity so that the Cu metal fine line is considered as an appropriate material for implementing a metal fine line. The above-mentioned visibility problem unique to the metal may be reduced by depositing an oxide layer on the metal. However, when a structure in which CuOx is deposited on the Cu metal is subjected to a high temperature post treatment after deposition, an interface of Cu/CuOx becomes unstable due to high diffusion property of Cu and thus a problem is incurred in a reflection color.

Therefore, the present application tries to maximize stability of the conductive structure including a metal layer and a darkening layer at a high temperature while implementing an appropriate color of the conductive structure.

The conductive structure according to an exemplary embodiment of the present application includes a substrate, a metal layer which is provided on the substrate and includes copper, a discoloration preventing layer provided on the metal layer, and a darkening layer which is provided on the discoloration preventing layer and includes one or more of copper oxide, copper nitride, copper oxynitride, aluminum oxide, aluminum nitride, and aluminum oxynitride.

In the present application, the discoloration preventing layer refers to a layer in which a change in reflectance of the entire structure is less than 5% when thermal treatment is performed at 150° C. for 30 minutes or longer.

In this specification, the darkening layer refers to a layer which has absorption to reduce an amount of light incident onto the metal layer and an amount of light reflected from the metal layer. The darkening layer may also be represented as a light absorbing layer, a light absorptive layer, a blackening layer, or a blackness layer.

According to the exemplary embodiment of the present application, a transparent substrate may be used as the substrate, but the substrate is not particularly limited, and for example, glass, a plastic substrate, or a plastic film may be used.

According to an exemplary embodiment of the present application, the discoloration preventing layer may serve to prevent copper of the metal layer from being diffused onto the darkening layer.

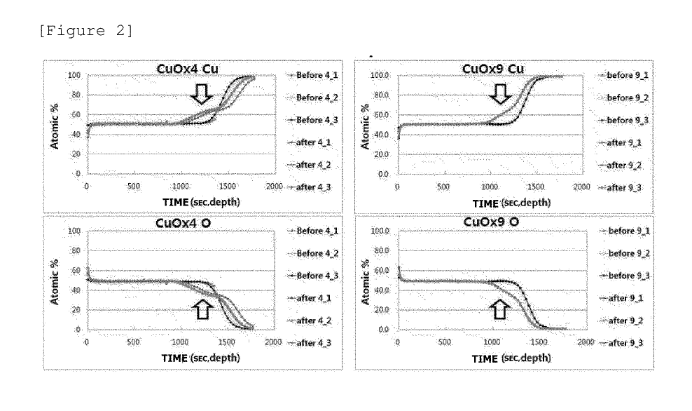

The conductive structure of the related art may include a structure in which a metal layer including copper and a darkening layer including a copper oxide are laminated. However, when the conductive structure including the laminated structure of Cu/CuO is heated at a normal pressure and 150° C. for 30 minutes, there is a problem in that reflectance of the conductive structure is increased and a darkening ability is lowered. The above-mentioned change is generated from an interface of Cu/CuO and specifically, a phenomenon in which CuO is changed into Cu₂O is found. As described above, a composition of the conductive structure of the related art before and after performing thermal treatment is illustrated in FIG. 2. That is, as described above, degeneration at the interface of Cu/CuO results in increase in reflectance of the conductive structure and change in a dark color, which may cause a problem during a process of manufacturing and evaluating a fine line product in the future.

A diffusion coefficient between Cu and CuO at 150° C. is approximately 1.3×10⁻²⁰ m²/s which is larger than a diffusion coefficient between Cu and Cu which is approximately 6.85×10⁻³¹ m²/s. By doing this, it is checked that Cu is diffused onto an interface of CuO at a temperature of 150° C. and degeneration at the interface of Cu/CuO is generated.

In the present application, the discoloration preventing layer is provided between the metal layer including copper and the darkening layer including the copper oxide so that copper of the metal layer is prevented from being diffused onto the darkening layer. Therefore, the degeneration of the interface between the metal layer and the metal oxide layer may be suppressed and stability at a high temperature may be maximized.

According to an exemplary embodiment of the present application, the discoloration preventing layer may include one or more selected from a group consisting of Ti, Ru, Ta, TiN, Al, Cu, Ni, and an alloy thereof, but is not limited thereto. Further, a thickness of the discoloration preventing layer may be 0.1 to 30 nm, may be 5 to 15 nm, and may be 8 to 12 nm, but is not limited thereto.

According to an exemplary embodiment of the present application, the thickness of the metal layer may be 100 to 160 nm and may be 130 to 145 nm, but is not limited thereto. Furthermore, the thickness of the darkening layer may be 20 to 30 nm, but is not limited thereto.

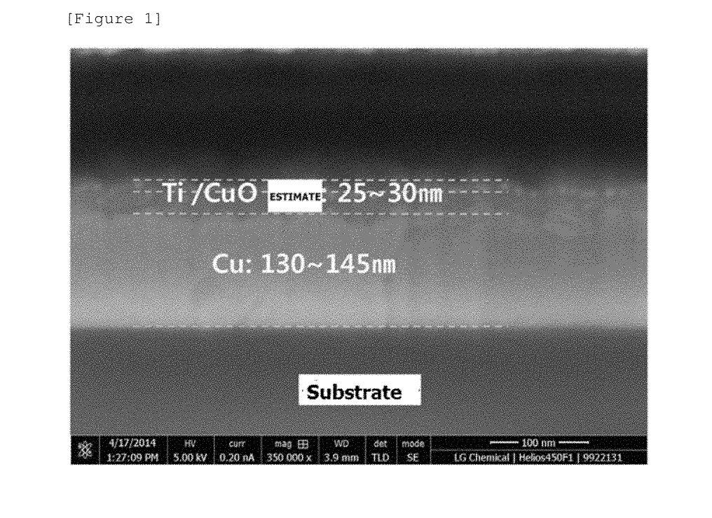

An example of the conductive structure according to an exemplary embodiment of the present application is illustrated in FIG. 1. FIG. 1 illustrates an order of laminating the substrate, the metal layer, the discoloration preventing layer, and the darkening layer and the metal layer, the discoloration preventing layer, and the darkening layer may not have a front surface layer included but have a pattern shape when being applied as a fine transparent electrode such as a touch screen panel in practice.

The conductive structure according to the exemplary embodiment of the present application may have a structure in which the darkening layer is provided on at least one surface of the metal layer.

The conductive structure according to the exemplary embodiment of the present application may have a structure in which the substrate, the darkening layer, the metal layer, and the darkening layer are sequentially laminated. Further, the conductive structure may include an additional metal layer and an additional darkening layer on the outermost darkening layer.

That is, the conductive structure according to an exemplary embodiment of the present application may have a structure of a substrate/a darkening layer/a discoloration preventing layer/a metal layer, a structure of a substrate/a metal layer/a discoloration preventing layer/a darkening layer, a structure of a substrate/a darkening layer/a discoloration preventing layer/a metal layer/a discoloration preventing layer/a darkening layer, a structure of a substrate/a metal layer/a discoloration preventing layer/a darkening layer/a discoloration preventing layer/a metal layer, a structure of a substrate/a darkening layer/a discoloration preventing layer/a metal layer/a discoloration preventing layer/a darkening layer/a discoloration preventing layer/a metal layer/a discoloration preventing layer/a darkening layer, or a structure of a substrate/a darkening layer/a discoloration preventing layer/a metal layer/a discoloration preventing layer/a darkening layer/a discoloration preventing layer/a metal layer/a discoloration preventing layer/a darkening layer/a discoloration preventing layer/a metal layer/a discoloration preventing layer/a darkening layer.

According to the exemplary embodiment of the present application, a sheet resistance of the conductive structure may be 1 Ω/square or more and 300 Ω/square or less, specifically 1 Ω/square or more and 100 Ω/square or less, more specifically 1 Ω/square or more and 50 Ω/square or less, and even more specifically 1 Ω/square or more and 20 Ω/square or less.

If the sheet resistance of the conductive structure is 1 Ω/square or more and 300 Ω/square or less, there is an effect replacing a known ITO transparent electrode. If the sheet resistance of the conductive structure is 1 Ω/square or more and 100 Ω/square or less or 1 Ω/square or more and 50 Ω/square or less, and specifically, 1 Ω/square or more and 20 Ω/square or less, since the sheet resistance is significantly low as compared to the case where the known ITO transparent electrode is used, there are advantages in that a RC delay is reduced when a signal is applied to significantly improve a touch recognition speed, and accordingly, a touch screen having a large area of 10 inches or more may be easily applied.

In the conductive structure, the sheet resistance of the metal layer or the darkening layer before patterning may be more than 0 Ω/square and 2 Ω/square or less, and specifically more than 0 Ω/square and 0.7 Ω/square or less.

When the sheet resistance is 2 Ω/square or less, particularly 0.7 Ω/square or less, the lower the sheet resistance of the metal layer or darkening layer prior to patterning, the easier the design and manufacturing process of the fine patterning proceeds. The sheet resistance of the conductive structure after patterning becomes low, and thus there is an effect that a reaction rate of the electrode is accelerated. The sheet resistance may be controlled depending on the thickness of the metal layer or the darkening layer.

The conductive structure according to an exemplary embodiment of the present application may have an average extinction coefficient k in a visible light region from 0.2 to 1.5, and specifically from 0.4 to 1.0. When the average extinction coefficient k is 0.2 or more, there is an effect that is capable of achieving darkening. The average extinction coefficient k may also be referred to as an absorption coefficient, and is a factor that determines the transmittance of the conductive structure, as a measure which may define how strongly the conductive structure absorbs light at a specific wavelength. For example, in the case of a transparent dielectric material, k<0.2, which is a very small value. However, the higher the content of a metal component in a material, the higher the k value is. If the amount of metal components is more increased, transmission hardly occurs, mostly, only surface reflection occurs on metal, and the extinction coefficient k is more than 1.5, which is not desirable in formation of the darkening layer.

In an exemplary embodiment of the present application, the conductive structure may have an average refractive index from 2 to 3 in a visible ray region.

In this specification, the visible ray region means a region having a wavelength from 360 to 820 nm.

In an exemplary embodiment of the present invention, the darkening layer may have a total reflectance of 20% or less, specifically 15% or less, more specifically 10% or less, and even more specifically 5% or less, and 3% or less. The smaller the total reflectance, the better the effect is.

The measurement of the total reflectance may be performed in a direction opposite to a surface on which the darkening layer is in contact with the metal layer. When the measurement is performed in this direction, the total reflectance may be 20% or less, specifically 15% or less, more specifically 10% or less, and even more specifically 5% or less, and 3% or less. The smaller the reflectance, the better the effect is.

In addition, the darkening layer may be provided between the metal layer and the substrate and the total reflectance may be measured in the substrate side. When the total reflectance is measured in the substrate side, the total reflectance may be 20% or less, specifically 15% or less, more specifically 10% or less, and even more specifically 5% or less, and 3% or less. The smaller the total reflectance, the better the effect is.

Further, when the thermal treatment is performed in the condition of 150° C. for 30 minutes or longer, change in the total reflectance of the conductive structure may be less than 5%.

In this specification, the total reflectance means a reflectance to light having a wavelength from 300 nm to 800 nm, specifically from 380 nm to 780 nm, and more specifically 550 nm, which has been incident onto a surface at 90° to be measured after treating a surface opposite to the surface to be measured with a black layer (perfect black).

According to the exemplary embodiment of the present application, the total reflectance of the darkening layer of the conductive structure may be 20% or less, specifically 15% or less, more specifically 10% or less, and even more specifically 6% or less. The smaller the total reflectance, the better the effect is.

In this specification, the total reflectance may be a value measured based on a wavelength value from 300 nm to 680 nm, specifically from 450 nm to 650 nm, and more specifically 550 nm in reflection light reflected by a target pattern layer or conductive structure to which light is incident when the incident light is defined as 100%.

According to the exemplary embodiment of the present application, a luminance value L* of the conductive structure may be 50 or less and more specifically 20 or less based on an L*a*b* color coordinate of CIE (Commission Internationale de l'Eclairage). It is advantageous that the smaller the luminance value, the lower the total reflectance becomes.

In addition, in the conductive structure according to the exemplary embodiment of the present application, the darkening layer may be directly provided on the substrate, the metal layer, or the discoloration preventing layer while a bonding layer or adhesive layer is not interposed therebetween. The bonding layer or adhesive layer may affect durability or optical properties. In addition, a method for manufacturing the conductive structure according to the exemplary embodiment of the present application is significantly different from that of the case where the bonding layer or adhesive layer is used. Moreover, in the exemplary embodiment of the present application, an interface property between the substrate, the metal layer, or the discoloration preventing layer and the darkening layer is excellent as compared to the case where the bonding layer or adhesive layer is used.

According to the exemplary embodiment of the present application, the darkening layer may be formed of a single layer, or a plurality of layers of two or more layers.

According to the exemplary embodiment of the present application, it is desirable that the darkening layer have an achromatic color. At this time, the color in the achromatic color series means a color that does not selectively absorb light incident to the surface of an object and appears until the light is evenly reflected and absorbed with respect to the wavelength of each component.

Further, a method for manufacturing a conductive structure according to an exemplary embodiment of the present application includes forming a metal layer including copper on a substrate, forming a discoloration preventing layer on the metal layer, and forming a darkening layer including one or more of copper oxide, copper nitride, copper oxynitride, aluminum oxide, aluminum nitride, and aluminum oxynitride on the discoloration preventing layer.

In the method for manufacturing a conductive structure according to an exemplary embodiment of the present application, description of the substrate, the metal layer, the discoloration preventing layer, and the darkening layer is the same as the above description, so that detailed description thereof will be omitted.

According to an exemplary embodiment of the present application, the metal layer, the discoloration preventing layer, or the darkening layer may be independently formed by an evaporation deposition method or a sputtering process, but are not limited thereto.

According to an exemplary embodiment of the present application, the metal layer, the discoloration preventing layer, or the darkening layer are formed using the evaporation deposition method, so that the color of the darkening layer is maintained and a deposition speed may be accelerated.

The evaporation deposition may use an electron beam evaporation method.

According to an exemplary embodiment of the present application, the evaporation deposition method may be performed by a process of directly evaporating one or more selected from a group consisting metal, metal oxide, metal nitride, and metal oxynitride to be deposited.

Further, in the present application, in order to accelerate the deposition speed and solve a problem in that the deposited darkening layer is easily discolored in the atmosphere, the evaporation deposition method may be performed by a process of evaporating metal and activating O₂ or N₂ gas to generate metal oxide, metal nitride, or metal oxynitride. In this case, the O₂ or N₂ gas may be activated using an ion gun, but is not limited thereto.

More specifically, the O₂ or N₂ gas may be activated using a filament type ion gun. The thermal electron from a filament is accelerated by an electromagnetic field to perform cyclotron movement and the O₂ or N₂ gas which is neutral is ionized during this process. The ionized electron moves toward the substrate and meets an atom of the metal which moves by the evaporation deposition to form oxide or nitride.

A condition for activating the O₂ or N₂ gas includes filament voltage, current, or a flowing gas amount. A voltage of 200 V and a current of 5 A are used to activate O₂ and a flow of the gas may be 20 sccm in this case. A voltage of 100V and a current of 5 A are used to activate N₂ and an amount of the gas may be 28 sccm in this case. In order to activate O₂ or N₂ gas, a voltage between 100 V and 300 V and a current between 5 and 10 A may be used. The darkening may be achieved in the range of 0.5 to 10 A/s of a deposition amount of metal. In the case of CuOx, a composition of the deposited oxide layer, that is, Cu:O is 1:1.

According to an exemplary embodiment of the present application, a process of individually or simultaneously patterning the metal layer, the discoloration preventing layer, and the darkening layer is further included.

That is, according to the method for manufacturing a conductive structure according to an exemplary embodiment of the present application, a metal layer is formed on a substrate, a discoloration preventing layer is formed on the metal layer, a darkening layer is formed on the discoloration preventing layer, and then the metal layer, the discoloration preventing layer, and the darkening layer are simultaneously patterned to form a metal pattern, a discoloration preventing layer pattern, and a darkening pattern.

Still another exemplary embodiment of the present application provides an electronic element including the conductive structure.

The electronic element includes a touch screen pane, a display device, or a solar cell, but is not limited thereto.

More specifically, for example, in an electrostatic capacity-type touch screen panel, the conductive structure according to an embodied example of the present invention may be used as a touch sensitive type electrode substrate.

The touch screen panel may further include an additional structure in addition to the above-described conductive structure including the substrate, the metal layer, the discoloration preventing layer, and the darkening layer. In this case, two structures may be disposed in the same direction, and may be disposed in directions opposite to each other. Two or more structures that may be included in the touch screen panel according to the present invention do not need to have the same structure, and only any one and desirably the structure that is closest to the user may include the substrate, the metal layer, the discoloration preventing layer, and the darkening pattern layer, and the additionally provided structure may not include the patterned darkening layer. Further, the layer laminate structures in two or more structures may be different from each other. When two or more structures are included, an insulating layer may be provided therebetween. At this time, a function as an adhesive layer may be additionally imparted to the insulating layer.

The touch screen panel according to the exemplary embodiment of the present application may include a lower substrate; an upper substrate; and an electrode layer provided on any one surface of a surface of the lower substrate that is in contact with the upper substrate and a surface of the upper substrate that is in contact with the lower substrate or both the surfaces. The electrode layer may serve to detect an X-axis position and a Y-axis position.

In this case, one or two of the electrode layer provided on the lower substrate and the surface of the lower substrate that is in contact with the upper substrate; and the electrode layer provided on the upper substrate and the surface of the upper substrate that is in contact with the lower substrate may be the conductive structure according to the exemplary embodiment of the present application. When only any one of the electrode layers is the conductive structure according to the exemplary embodiment of the present application, the other one may have a metal pattern known in the art.

When an electrode layer is provided on one surface of both the upper substrate and the lower substrate to form an electrode layer having two layers, an insulating layer or a spacer may be provided between the lower substrate and the upper substrate such that the interval of the electrode layer is constantly maintained and contact thereof does not occur. The insulating layer may include an adhesive or a UV or thermally curable resin. The touch screen panel may further include a ground terminal connected to the metal pattern in the above-described conductive structure. For example, the ground terminal may be formed at an edge portion of a surface on which the metal pattern of the substrate is formed. In addition, at least one of an antireflection film, a polarizing film, and an anti-fingerprint film may be provided on at least one surface of a laminate including the conductive structure. A different type of functional film may be further included in addition to the above-described functional film depending on the design specification. The above-described touch screen panel may be applied to a display device, such as an OLED display panel (PDP), a liquid crystal display (LCD), a cathode-ray tube (CRT), and a PDP.

The touch screen panel according to an exemplary embodiment of the present application may further include an electrode unit or a pad unit on the conductive structure and in this case, an effective screen unit may be formed of the same conductor as the electrode unit and the pad unit.

In the touch screen panel according to the exemplary embodiment of the present application, the darkening layer may be provided at a side observed by a user.

Further, in the display device, the conductive structure according to the exemplary embodiment of the present application may be used in a color filter substrate or a thin film transistor substrate.

Further, the solar cell may include an anode electrode, a cathode electrode, a photoactive layer, a hole transporting layer and/or an electron transporting layer, and the conductive structure according to an exemplary embodiment of the present application may be used as the anode electrode and/or the cathode electrode.

The conductive structure may replace the ITO of the related art in a display device or a solar cell, and may be utilized for a flexible use. Furthermore, the conductive structure may be utilized as a next-generation transparent electrode along with CNT, a conductive polymer, and graphene.

### [Mode for Invention]

Hereinafter, the present invention will be described in detail with reference to Examples. However, the following Examples are set forth to illustrate the present invention, but the scope of the present invention is not limited thereto.

### EXAMPLES

### Example 1

A Cu layer having a thickness of 100 nm was formed on a glass substrate using a single Cu target by an evaporation deposition method. A Ti layer was formed thereon as a discoloration preventing layer using the evaporation deposition method.

Next, a CuOx darkening layer was formed on the discoloration preventing layer using the evaporation deposition method. In this case, as a method for forming the CuOx darkening layer, an evaporation deposition method which simultaneously evaporates Cu and activates O₂ using an ion gun was used.

### Example 2

Except using a Cu—Ni alloy layer as the discoloration preventing layer in Example 1, the same manner as Example 1 was performed.

### Example 3

Except using an Al layer as the discoloration preventing layer in Example 1, the same manner as Example 1 was performed.

### Comparative Example 1

A Cu layer having a thickness of 100 nm was formed on a glass substrate using a single Cu target by an evaporation deposition method.

Next, a CuOx darkening layer was formed on the Cu layer using an evaporation deposition method. In this case, as a method for forming the CuOx darkening layer, an evaporation deposition method which simultaneously evaporates Cu and activates O₂ using an ion gun was used.

### Experimental Example 1

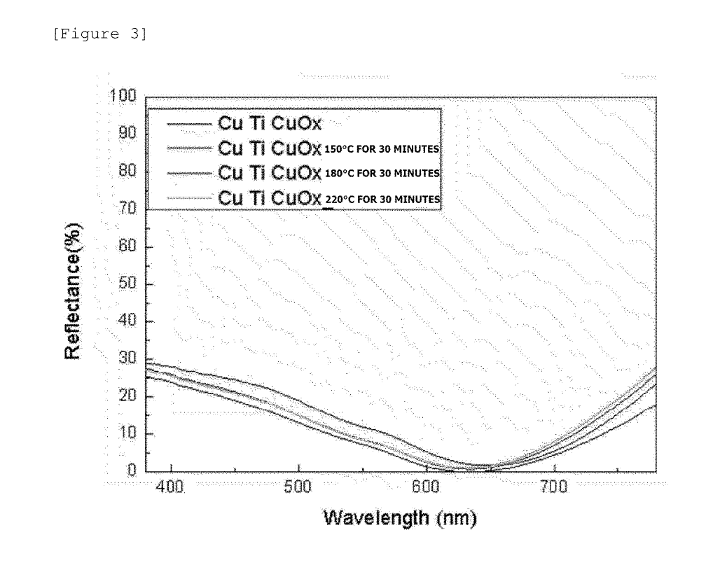

A conductive structure having a Cu/Ti/CuOx structure which was manufactured in Example 1 was subject to a thermal treatment at 150° C. for 30 minutes, 180° C. for 30 minutes, and 220° C. for 30 minutes, and then reflectance of the conductive structure was measured. The results are illustrated in following Table 1 and FIG. 3.

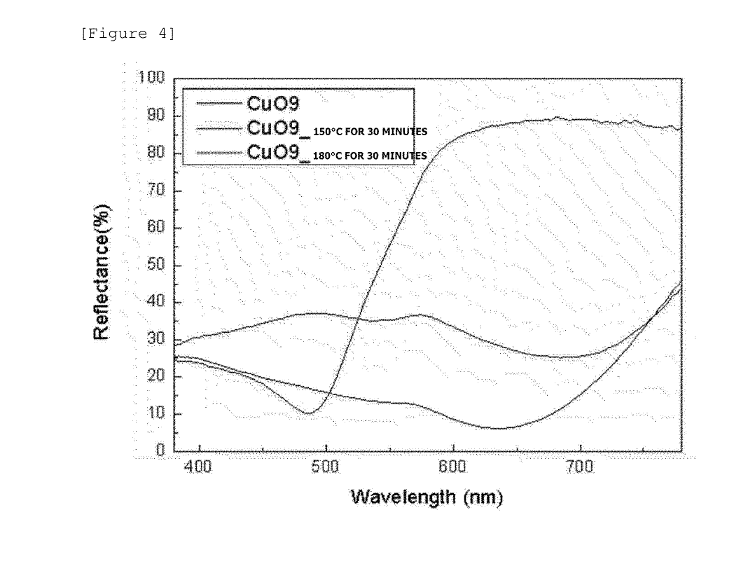

A conductive structure having a Cu/CuOx structure which was manufactured in Comparative Example 1 was subject to a thermal treatment at 150° C. for 30 minutes and 180° C. for 30 minutes, and then reflectance of the conductive structure was measured. The results are illustrated in following Table 1 and FIG. 4.

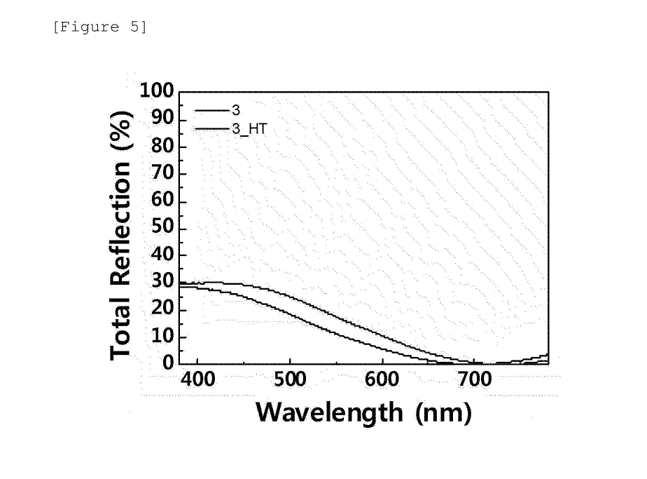

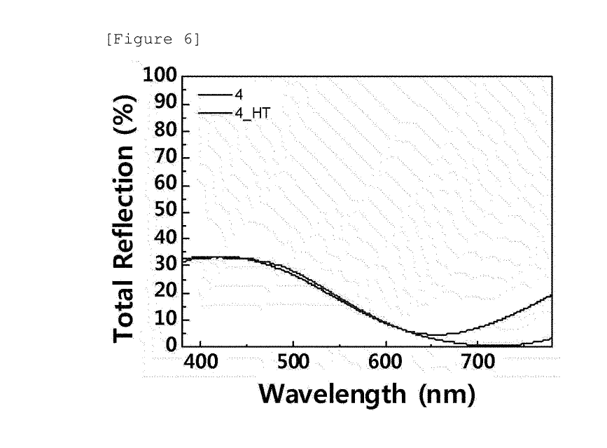

A conductive structure having a Cu/Cu-Ni/CuOx structure which was manufactured in Example 2 and a conductive structure having a Cu/Al/CuOx structure which was manufactured in Example 3 were subject to a thermal treatment at 150° for 30 minutes, and then reflectance of the conductive structure was measured. The results are illustrated in FIGS. 5 and 6.

TABLE 1

| | Thermal | Reflectance (%) | | |
|---|---|---|---|---|
| | treatment | Average | Maximum | Minimum |
| | condition | value | value | value |
| Example 1 | — | 10.24 | 25.47 | 0.06 |
| | 150° C., 30 min | 12.62 | 27.39 | 0.78 |
| | 180° C., 30 min | 14.00 | 29.06 | 1.72 |
| | 220° C., 30 min | 12.95 | 28.10 | 1.13 |
| Comparative | — | 17.63 | 46.21 | 6.33 |
| Example 1 | 150° C., 30 min | 32.49 | 44.17 | 25.19 |
| | 180° C., 30 min | 58.43 | 89.71 | 10.30 |

As represented in the result, the conductive structure according to the exemplary embodiment of the present application includes the discoloration preventing layer between the metal layer including copper and the darkening layer including copper oxide, so that the reflectance hardly changes even in the thermal treatment at 220° for 30 minutes. Accordingly, the conductive structure according to the exemplary embodiment of the present application may lower the reflectance to approximately 20% at a long wavelength and lower an average reflectance to approximately 7%.

### Experimental Example 2

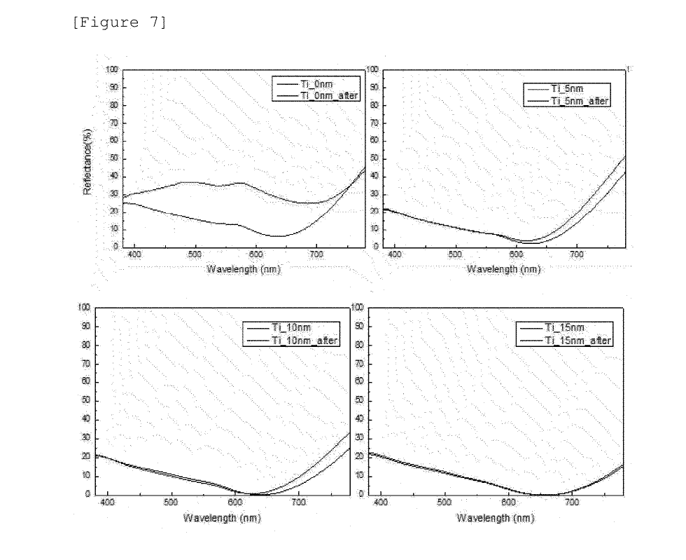

A conductive structure was manufactured by adjusting a thickness of a Ti layer which is the discoloration preventing layer in Example 1 and a discoloration degree at a high temperature of the Ti layer according to a thickness was measured. The result was represented in the following Table 2 and FIG. 7. The thermal treatment is performed at 150° for 30 minutes.

TABLE 2

| | Thickness of Ti layer | | | |
|---|---|---|---|---|
| | 0 | 5 nm | 10 nm | 15 nm |
| Reflectance (%) before thermal | 17.63 | 13.76 | 9.89 | 8.72 |
| treatment | | | | |
| Reflectance (%) after thermal | 32.49 | 16.18 | 11.28 | 9.24 |
| treatment | | | | |
| Change in reflectance | 14.85 | 2.43 | 1.39 | 0.51 |

### Experimental Example 3

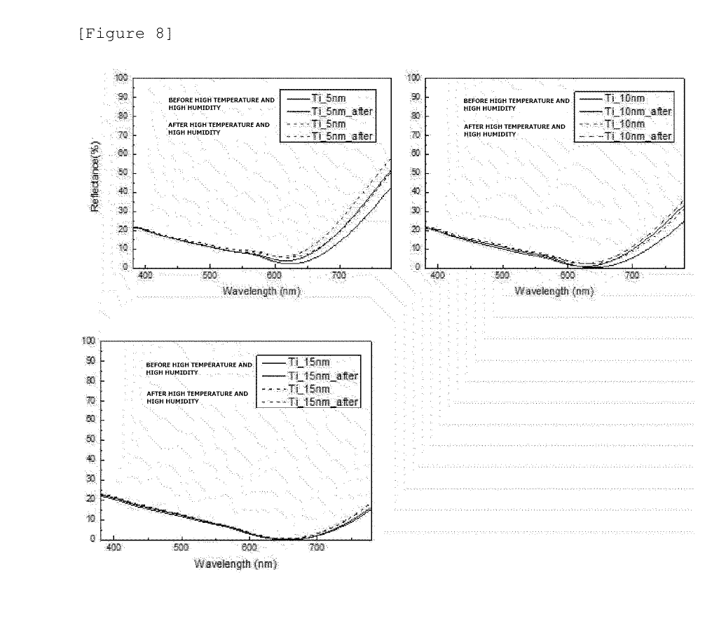

A conductive structure was manufactured by adjusting a thickness of a Ti layer which is the discoloration preventing layer in Example 1 and a high temperature-high humidity stability of the Ti layer according to a thickness was measured. This experiment is an experiment for checking a change in reflectance in a high temperature and high humidity environment evaluation depending on whether to perform a thermal treatment and is an environment evaluation in a condition which is more severe than a result obtained by evaluating only a high temperature and high humidity environment. The result was represented in the following Table 3 and FIG. 8. The thermal treatment was performed at 150° C. for 30 minutes and a high temperature and high humidity test was performed at 85° C. and 85% of humidity for 100 hours.

TABLE 3

| | | Reflectance (%) according | | |
|---|---|---|---|---|
| | | to thickness of Ti layer | | |
| | | 5 nm | 10 nm | 15 nm |
| Before | Before high | 13.76 | 9.89 | 8.72 |
| thermal | temperature-high | | | |
| treatment | humidity | | | |
| | After high temperature- | 16.74 | 11.98 | 9.90 |
| | high humidity (85° C., | | | |
| | 85%, 100 hr.) | | | |
| | Change in reflectance | 2.98 | 2.09 | 1.18 |
| | (%) | | | |
| After | Before high | 16.18 | 11.28 | 9.24 |
| thermal | temperature-high | | | |
| treatment | humidity | | | |
| | After high temperature- | 18.39 | 12.57 | 9.83 |
| | high humidity (85° C., | | | |
| | 85%, 100 hr.) | | | |
| | Change in reflectance | 2.21 | 1.29 | 0.59 |
| | (%) | | | |

As represented in the result, the conductive structure according to an exemplary embodiment of the present application may prevent reflection by a conductive pattern without affecting conductivity of the conductive pattern, and may improve concealment of the conductive pattern by improving absorbance of the conductive pattern. Further, the conductive structure according to the exemplary embodiment of the present application includes a discoloration preventing layer between a metal layer including copper and a darkening layer including one or more of copper oxide, copper nitride, copper oxynitride, aluminum oxide, aluminum nitride, and aluminum oxynitride, thereby preventing copper of the metal layer from being diffused onto the darkening layer. Therefore, the degeneration of the interface between the metal layer and the darkening layer may be suppressed and stability at a high temperature and high humidity may be maximized.

1. A conductive structure, comprising:
a substrate;
a metal layer which is provided on the substrate and includes copper;
a discoloration preventing layer provided on the metal layer; and
a darkening layer which is provided on the discoloration preventing layer and includes one or more of copper oxide, copper nitride, copper oxynitride, aluminum oxide, aluminum nitride, and aluminum oxynitride.

2. The conductive structure of claim 1, wherein the discoloration preventing layer includes one or more selected from a group consisting of Ti, Ru, Ta, TiN, Al, Cu, Ni, and an alloy thereof.

3. The conductive structure of claim 1, wherein the metal layer has a thickness of 100 μm to 160 μm.

4. The conductive structure of claim 1, wherein the discoloration preventing layer has a thickness of 0.1 nm to 30 nm.

5. The conductive structure of claim 1, wherein the darkening layer has a thickness of 20 nm to 30 nm.

6. The conductive structure of claim 1, wherein total reflectance measured in a direction opposite to a surface of the darkening layer which is in contact with the metal layer, is 20% or less.

7. The conductive structure of claim 6, wherein when a thermal treatment is performed under a condition of 150° C. for 30 minutes or longer, change in the total reflectance of the conductive structure is less than 5%.

8. The conductive structure of claim 1, wherein a sheet resistance of the conductive structure is 1 Ω/square or more and 300 Ω/square or less.

9. The conductive structure of claim 1, wherein the conductive structure has an average extinction coefficient (k) from 0.4 to 1.0 in a visible ray region.

10. The conductive structure of claim 1, wherein the conductive structure has a luminance value (L*) of 50 or less based on the CIE L*a*b* color coordinate.

11. A method for manufacturing a conductive structure, the method comprising:
forming a metal layer including copper on a substrate;
forming a discoloration preventing layer on the metal layer; and
forming a darkening layer including one or more of copper oxide, copper nitride, copper oxynitride, aluminum oxide, aluminum nitride, and aluminum oxynitride on the discoloration preventing layer.

12. The method of claim 11, wherein the discoloration preventing layer includes one or more selected from a group consisting of Ti, Ru, Ta, TiN, Al, Cu, Ni, and an alloy thereof.

13. The method of claim 11, wherein the metal layer, the discoloration preventing layer, or the darkening layer are independently formed by an evaporation deposition method or a sputtering process.

14. An electronic element comprising the conductive structure of claim 1.
